(19) United States
(12) Patent Application Publication
(10) Pub. No.: US 2014/0108132 A1
(43) Pub. Date: Apr. 17, 2014

(54) PRESERVING ELECTRONIC ADVERTISEMENTS IDENTIFIED DURING A COMPUTING SESSION

(71) Applicant: salesforce.com, inc., San Francisco, CA (US)

(72) Inventor: Christopher De Gour, San Jose, CA (US)

(21) Appl. No.: 14/042,146

(22) Filed: Sep. 30, 2013

Related U.S. Application Data
(60) Provisional application No. 61/712,359, filed on Oct. 11, 2012.

(51) Int. Cl. G06Q 30/02

(52) U.S. Cl. CPC G06Q 30/0246
USPC 705/14.45

(57) ABSTRACT

Disclosed are implementations of systems, apparatus, methods and computer-readable storage media for preserving electronic advertisements identified during a computing session. In some implementations, user input data indicating a selection of an electronic advertisement is received. Ad impression data is stored that identifies: the selected electronic advertisement as a candidate for later access, and one or more context attributes providing contextual information identifying a user interface environment in which the electronic advertisement was selected. The ad impression data including the one or more context attributes can be provided to a display device.

### PRIORITY DATA

This patent document claims priority to co-pending and commonly assigned U.S. Provisional Patent Application No. 61/712,359, titled “System and Method for Providing a Mobile Advertising Platform”, by Christopher De Gour, filed on Oct. 11, 2012 (Attorney Docket No. 1067PROV), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to providing electronic advertising services using a database system and, more specifically, to techniques for managing data related to electronic advertisements.

### BACKGROUND

Online forums have become a predominant venue for delivering advertisements to potential consumers. Computer users who carry handheld devices such as smartphones and tablets are often bombarded with various electronic advertisements when using their devices. For instance, a user who runs a Google® search may receive electronic ads on a search results page that are tailored to search terms. Another user who accesses a Facebook® page may be served with various ads on the page. Often these ads are a nuisance to the user, particularly when display screen real estate is limited, as is the case with smaller devices such as smartphones. In some instances, an advertiser is successful to the extent that a user finds an ad interesting. Nonetheless, the ad can still be distracting when the user had a different goal in mind at the outset of a computing session.

### BRIEF DESCRIPTION OF THE DRAWINGS

The included drawings are for illustrative purposes and serve only to provide examples of possible structures and operations for the disclosed inventive systems, apparatus, methods and computer-readable storage media for preserving electronic advertisements identified during a computing session. These drawings in no way limit any changes in form and detail that may be made by one skilled in the art without departing from the spirit and scope of the disclosed implementations.

FIG. 1A shows a block diagram of an example of an environment 10 in which an on-demand database service can be used in accordance with some implementations.

FIG. 1B shows a block diagram of an example of some implementations of elements of FIG. 1A and various possible interconnections between these elements.

FIG. 2A shows a system diagram illustrating an example of architectural components of an on-demand database service environment 200 according to some implementations.

FIG. 2B shows a system diagram further illustrating an example of architectural components of an on-demand database service environment according to some implementations.

FIG. 3 shows a flowchart of an example of a computer implemented method 300 for preserving electronic advertisements identified during a computing session, performed in accordance with some implementations.

FIG. 4 shows a flowchart of an example of a computer implemented method 400 for preserving electronic advertisements identified during a computing session, performed in accordance with some implementations.

FIG. 5 shows a flowchart of an example of a computer implemented method 500 for providing electronic advertisements, performed in accordance with some implementations.

FIG. 6 shows an example of a presentation of a social networking group page 600 in the form of a graphical user interface (GUI) as displayed on a user's computing device, in accordance with some implementations.

FIG. 7 shows an example of a presentation 700 of a social networking news feed page in the form of a GUI as displayed on a user's computing device, in accordance with some implementations.

FIG. 8 shows an example of an updated presentation 800 of the news feed page of FIG. 7 as displayed on a user's computing device, in accordance with some implementations.

FIG. 9 shows an example of an arrangement of database tables configured to store ad impressions, user IDs, and ad data, in accordance with some implementations.

FIG. 10 shows an example of a pane 1004 in the form of a GUI including a list 1008 of ad impressions and related data retrieved from one or more database tables.

### DETAILED DESCRIPTION

Examples of systems, apparatus, methods and computer-readable storage media according to the disclosed implementations are described in this section. These examples are being provided solely to add context and aid in the understanding of the disclosed implementations. It will thus be apparent to one skilled in the art that implementations may be practiced without some or all of these specific details. In other instances, certain process/method operations also referred to herein as “blocks,” have not been described in detail in order to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

Various implementations described and referenced herein are directed to different methods, apparatus, systems, and computer-readable storage media for preserving electronic advertisements identified during one or more computing sessions.

Joseph Olsen is an iPhone® user. Joseph frequently but briefly checks his iPhone® whenever he is standing in line at the coffee shop, at the train station, during his train ride to-and-from work, and at various free moments on the weekend. On a given day, Joseph may briefly turn on his iPhone® over 100 times but only use it for a matter of seconds or minutes each time. When standing in line at the coffee shop, for example, Joseph may only have a minute or two to skim one thing of interest before putting his iPhone® away. While Joseph often sees electronic ads on various web pages, most of the time, Joseph feels that he simply does not have the time and display screen space to click an ad, open an additional window or navigate away from the page he was viewing, and investigate any ad he happens to find interesting.

When initiating a web browsing session on his iPhone® or other computing device, Joseph may want to browse various web sites for work or pleasure. Joseph may access customer portals, social networking sites, etc. Joseph, like any user, is presented with ads on various web pages. Regardless of whether Joseph finds the content of an ad interesting, he often feels that all of the ads are a nuisance since they are peripheral to the information he was seeking at the outset of the browsing session. For example, Joseph may have started the session to book plane tickets or to watch funny puppy videos. Even ads related to travel or animals may be a nuisance to Joseph because clicking on them would pull him away from pages showing ticket prices or puppy video content. That is, clicking on such ads would load a different page dedicated to the advertisement. Joseph would then have to exert effort to navigate his way back to the ticket or puppy video page. Thus, even if Joseph were to click on an ad he found interesting, he likely would be in a negative sentiment when viewing the ad, because whatever he was originally doing would have been interrupted.

Some of the disclosed implementations are configured to preserve ads which a user finds interesting for display at a later time when the user so desires. In some implementations, the effect of clicking on or otherwise selecting an ad is modified to preserve data related to the ad for later viewing, rather than immediately loading a page on which the ad is displayed. In this way, during a given computing session, the user can select an ad he finds interesting and does not have to navigate away from a page he was viewing. Since the user is in control of selecting the ad and choosing when to view it, the user is more likely to be in a positive sentiment when viewing ads at a later time.

Some of the disclosed methods and apparatus can be implemented as a local application on a user's computing device such as a smartphone, in some examples, while in other examples, the disclosed techniques are implemented by one or more servers providing cloud-based services over the Internet. For instance, some implementations of the disclosed methods can be performed by a server as one of a variety of services delivered through a social networking system such as Chatter®. In some other implementations, the disclosed techniques are performed in-part by a server and in-part by a user's computing device, where the server and the user's device cooperate to store and exchange data as described in greater detail below.

The disclosed techniques provide for storing contextual information relating to a user interface environment such as a web page, web site, or application on which an ad was originally displayed on a user's device. Such contextual information can be stored when the user selects an ad for later viewing. For example, database tables can be arranged and maintained using a relational database management system (RDBMS) to store and relate: i) context attributes collectively describing user interface environments in which users select ads, ii) user identifiers (IDs) of users who select ads, and iii) ad data including content of or otherwise identifying selected ads.

With some of the disclosed implementations, a user's selection of an ad creates an entry in an impression table. The impression table entry, also referred to herein as an “ad impression”, includes data identifying the selected ad and one or more context attributes providing contextual information about the user interface environment in which the ad was selected. In some implementations, the impression table entry points to an entry in an ad table identifying the selected ad. The impression table entry can also point to an entry in a user ID table storing the user ID of the user who selected the ad.

For example, a user ID table can store: unique user IDs used to log in to user accounts of various web sites, user IDs identified by tokens in browser software installed on respective users' computing devices, and/or particular user computing devices themselves. For example, salesforce.com, inc. provides customer portals having pages on which ads are served. One or more servers cooperating to provide such a customer portal can be configured to maintain a user ID table storing user IDs. In another example, a social networking system like Facebook® can have a server configured to store and maintain user IDs on a database table.

In some implementations, later access of a particular web site, web page, or application through which an ad was originally displayed and selected causes a list of ad impressions to be displayed on the user's device. In some other implementations, the list is displayed when the user powers on or wakes up the device used to originally select the ad. Ad impressions stored for a particular user and relevant ad content can be retrieved from the database tables described above, by way of example. In some implementations, the ad impressions list is configured to only identify recently and/or most frequently visited advertisements, accompanied by the contextual information of when the user selected the ads. Preferably, each item in the list includes selected context attributes to trigger the user's memory of what the user was doing when he first saw the ad. For example, items in the list can include representations of content of the selected ads in the form of an icon or thumbnail image generated from the ad content and stored in a datable table. The list is interactive, so clicking on an item in the list loads a page on which the ad is displayed. Users can delete an item when they are no longer interested, and users can store items for spans of time.

In some implementations, contextual information regarding system events and user actions occurring during a computing session when a user selected an ad can be monitored and reported as described in greater detail below. For example, by analyzing context attributes, one can determine a relevance of the ad to an article on a web page that the user was presumably reading. Using the disclosed techniques, packages of contextual information can be gathered to identify which advertisements appeared to have an impact on which users or demographics of users in which environments. Some of the disclosed implementations thus provide a reference point for a marketing analysis to improve the targeting of advertisements, particularly to users of portable handheld devices such as smartphones and tablets. For example, one can monitor whether a user visited a particular ad after creating an ad impression. In other words, one can gauge a user's interest in the ad based on the contextual information. The act of creating an ad impression may indicate some level of interest, but additional questions can be answered to determine a higher or lower level of interest and thus determine the success of an ad or of a marketing campaign. For example, context attributes can be analyzed to answer questions such as: Did the user delete the ad from the list of ad impressions? Did the user click through the list to view the ad? For how long? Did the user save the ad impression for later access? How many times did the user access the ad?

Online social networks are increasingly becoming a common way to facilitate communication among people, any of whom can be recognized as users of a social networking system. One example of an online social network is Chatter®, provided by salesforce.com, inc. of San Francisco, Calif. salesforce.com, inc. is a provider of social networking services, customer relationship management (CRM) services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some online social networks can be implemented in various settings, including organizations. For instance, an online social network can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail below.

In some online social networks, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, an online social network may allow a user to follow data objects in the form of records such as cases, accounts, or opportunities, in addition to following individual users and groups of users. The “following” of a record stored in a database, as described in greater detail below, allows a user to track the progress of that record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be user-submitted messages or can otherwise be generated in response to user actions or in response to events. Examples of messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of an online social network. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within an online social network, an email notification or other type of network communication may be transmitted to all users following the user, group, or object in addition to the inclusion of the data as a feed item in one or more feeds, such as a user's profile feed, a news feed, or a record feed. In some online social networks, the occurrence of such a notification is limited to the first instance of a published input, which may form part of a larger conversation. For instance, a notification may be transmitted for an initial post, but not for comments on the post. In some other implementations, a separate notification is transmitted for each such information update.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a message, such as a user-generated post of text data, and a feed tracked update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a graphical user interface (GUI), for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Messages and feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and messages, such as posts, comments, likes, etc., can define group conversations and change over time.

An “entity feed” or “record feed” generally refers to a feed of feed items about a particular record in the database, such as feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” is a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

I. General Overview

Systems, apparatus, and methods are provided for implementing enterprise level social and business information networking. Such implementations can provide more efficient use of a database system. For instance, a user of a database system may not easily know when important information in the database has changed, e.g., about a project or client. Implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed right to the manager's feed page or other page.

Next, mechanisms and methods for providing systems implementing enterprise level social and business information networking will be described with reference to several implementations. First, an overview of an example of a database system is described, and then examples of tracking events for a record, actions of a user, and messages about a user or record are described. Various implementations about the data structure of feeds, customizing feeds, user selection of records and users to follow, generating feeds, and displaying feeds are also described.

II. System Overview

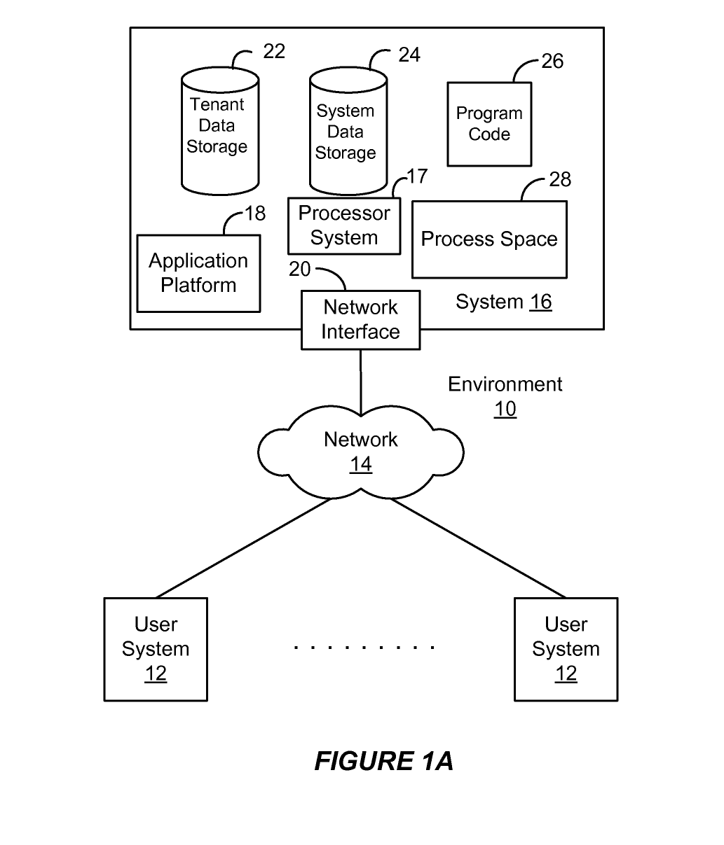

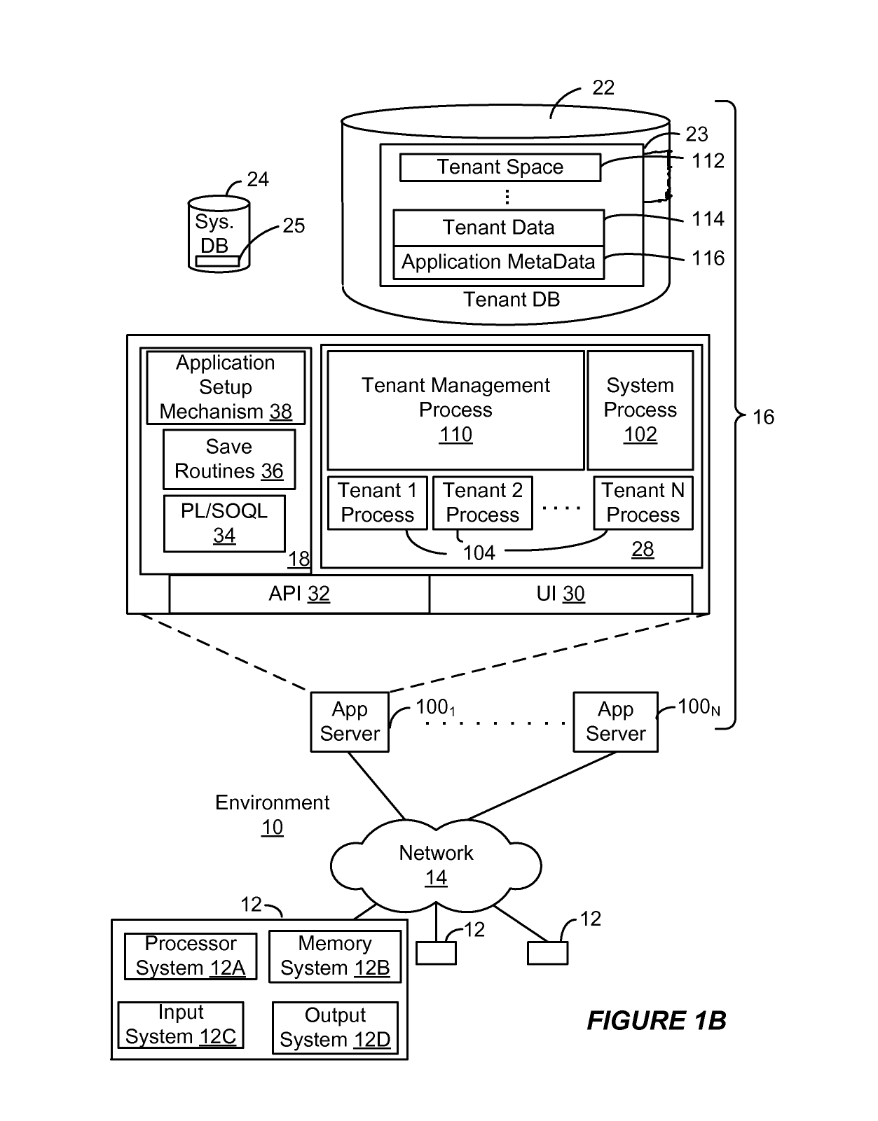

FIG. 1A shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 1A (and in more detail in FIG. 1B) user systems 12 might interact via a network 14 with an on-demand database service, which is implemented in the example of FIG. 1A as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to the salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 1A, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Web page content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 1A and 1B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 1B shows a block diagram of an example of some implementations of elements of FIG. 1A and various possible interconnections between these elements. That is, FIG. 1B also illustrates environment 10. However, in FIG. 1B elements of system 16 and various interconnections in some implementations are further illustrated. FIG. 1B shows that user system 12 may include processor system 12A, memory system 12B, input system 12C, and output system 12D. FIG. 1B shows network 14 and system 16. FIG. 1B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 100₁-100_{N}, system process space 102, tenant process spaces 104, tenant management process space 110, tenant storage space 112, user storage 114, and application metadata 116. In other implementations, environment 10 may not have the same elements as those listed above and/or may have other elements instead of, or in addition to, those listed above.

User system 12, network 14, system 16, tenant data storage 22, and system data storage 24 were discussed above in FIG. 1A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 1B, system 16 may include a network interface 20 (of FIG. 1A) implemented as a set of HTTP application servers 100, an application platform 18, tenant data storage 22, and system data storage 24. Also shown is system process space 102, including individual tenant process spaces 104 and a tenant management process space 110. Each application server 100, also referred to herein as an “app server”, may be configured to communicate with tenant data storage 22 and the tenant data 23 therein, and system data storage 24 and the system data 25 therein to serve requests of user systems 12. The tenant data 23 might be divided into individual tenant storage spaces 112, which can be either a physical arrangement and/or a logical arrangement of data. Within each tenant storage space 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage space 112. A UI 30 provides a user interface and an API 32 provides an application programmer interface to system 16 resident processes to users and/or developers at user systems 12. The tenant data and the system data may be stored in various databases, such as one or more Oracle databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain implementations, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one implementation, therefore, an interface system implementing a load balancing function (e.g., an F5 Big-IP load balancer) is communicably coupled between the application servers 100 and the user systems 12 to distribute requests to the application servers 100. In one implementation, the load balancer uses a least connections algorithm to route user requests to the application servers 100. Other examples of load balancing algorithms, such as round robin and observed response time, also can be used. For example, in certain implementations, three consecutive requests from the same user could hit three different application servers 100, and three requests from different users could hit the same application server 100. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 100 to request and update system-level and tenant-level data from system 16 that may involve sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

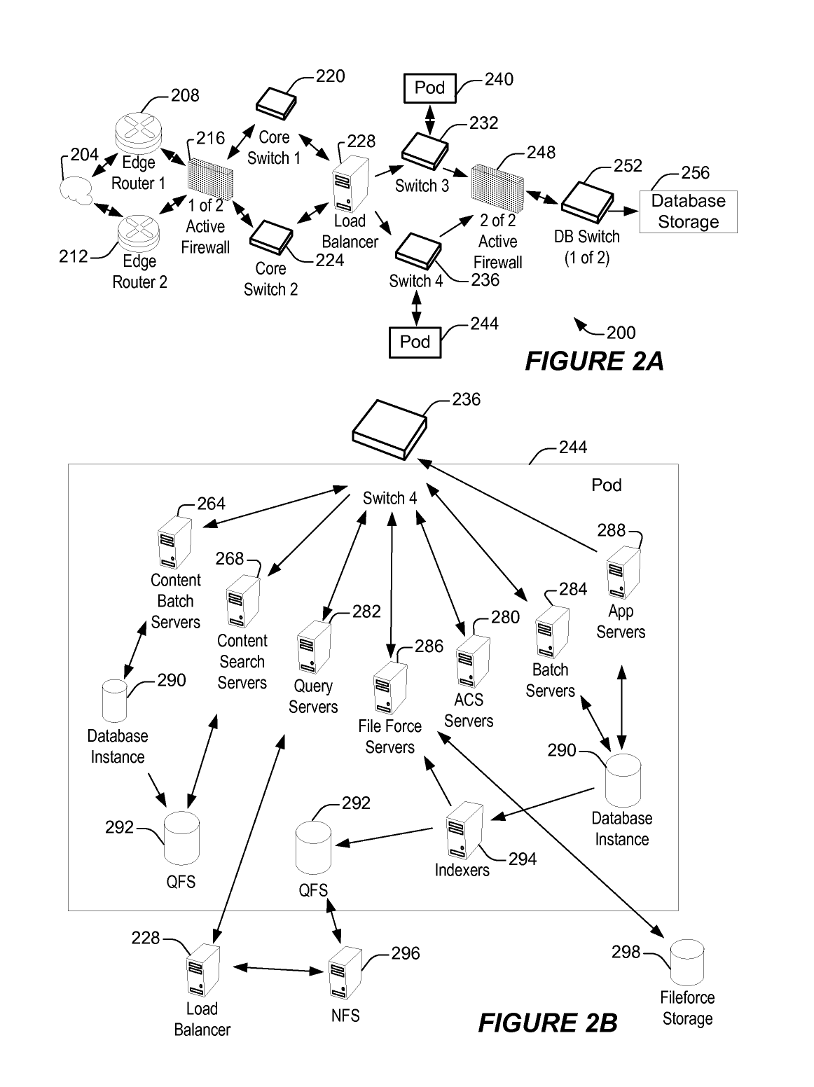

FIG. 2A shows a system diagram illustrating an example of architectural components of an on-demand database service environment 200 according to some implementations. A client machine located in the cloud 204, generally referring to one or more networks in combination, as described herein, may communicate with the on-demand database service environment via one or more edge routers 208 and 212. A client machine can be any of the examples of user systems 12 described above. The edge routers may communicate with one or more core switches 220 and 224 via firewall 216. The core switches may communicate with a load balancer 228, which may distribute server load over different pods, such as the pods 240 and 244. The pods 240 and 244, which may each include one or more servers and/or other computing resources, may perform data processing and other operations used to provide on-demand services. Communication with the pods may be conducted via pod switches 232 and 236. Components of the on-demand database service environment may communicate with a database storage 256 via a database firewall 248 and a database switch 252.

As shown in FIGS. 2A and 2B, accessing an on-demand database service environment may involve communications transmitted among a variety of different hardware and/or software components. Further, the on-demand database service environment 200 is a simplified representation of an actual on-demand database service environment. For example, while only one or two devices of each type are shown in FIGS. 2A and 2B, some implementations of an on-demand database service environment may include anywhere from one to many devices of each type. Also, the on-demand database service environment need not include each device shown in FIGS. 2A and 2B, or may include additional devices not shown in FIGS. 2A and 2B.

Moreover, one or more of the devices in the on-demand database service environment 200 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 204 is intended to refer to a data network or plurality of data networks, often including the Internet. Client machines located in the cloud 204 may communicate with the on-demand database service environment to access services provided by the on-demand database service environment. For example, client machines may access the on-demand database service environment to retrieve, store, edit, and/or process information.

In some implementations, the edge routers 208 and 212 route packets between the cloud 204 and other components of the on-demand database service environment 200. The edge routers 208 and 212 may employ the Border Gateway Protocol (BGP). The BGP is the core routing protocol of the Internet. The edge routers 208 and 212 may maintain a table of IP networks or ‘prefixes’, which designate network reachability among autonomous systems on the Internet.

In one or more implementations, the firewall 216 may protect the inner components of the on-demand database service environment 200 from Internet traffic. The firewall 216 may block, permit, or deny access to the inner components of the on-demand database service environment 200 based upon a set of rules and other criteria. The firewall 216 may act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 may be configured as network bridges that quickly route data between different components within the on-demand database service environment. In some implementations, the use of two or more core switches 220 and 224 may provide redundancy and/or reduced latency.

In some implementations, the pods 240 and 244 may perform the core data processing and service functions provided by the on-demand database service environment. Each pod may include various types of hardware and/or software computing resources. An example of the pod architecture is discussed in greater detail with reference to FIG. 2B.

In some implementations, communication between the pods 240 and 244 may be conducted via the pod switches 232 and 236. The pod switches 232 and 236 may facilitate communication between the pods 240 and 244 and client machines located in the cloud 204, for example via core switches 220 and 224. Also, the pod switches 232 and 236 may facilitate communication between the pods 240 and 244 and the database storage 256.

In some implementations, the load balancer 228 may distribute workload between the pods 240 and 244. Balancing the on-demand service requests between the pods may assist in improving the use of resources, increasing throughput, reducing response times, and/or reducing overhead. The load balancer 228 may include multilayer switches to analyze and forward traffic.

In some implementations, access to the database storage 256 may be guarded by a database firewall 248. The database firewall 248 may act as a computer application firewall operating at the database application layer of a protocol stack. The database firewall 248 may protect the database storage 256 from application attacks such as structure query language (SQL) injection, database rootkits, and unauthorized information disclosure.

In some implementations, the database firewall 248 may include a host using one or more forms of reverse proxy services to proxy traffic before passing it to a gateway router. The database firewall 248 may inspect the contents of database traffic and block certain content or database requests. The database firewall 248 may work on the SQL application level atop the TCP/IP stack, managing applications' connection to the database or SQL management interfaces as well as intercepting and enforcing packets traveling to or from a database network or application interface.

In some implementations, communication with the database storage 256 may be conducted via the database switch 252. The multi-tenant database storage 256 may include more than one hardware and/or software components for handling database queries. Accordingly, the database switch 252 may direct database queries transmitted by other components of the on-demand database service environment (e.g., the pods 240 and 244) to the correct components within the database storage 256.

In some implementations, the database storage 256 is an on-demand database system shared by many different organizations. The on-demand database system may employ a multi-tenant approach, a virtualized approach, or any other type of database approach. An on-demand database system is discussed in greater detail with reference to FIGS. 1A and 1B.

FIG. 2B shows a system diagram further illustrating an example of architectural components of an on-demand database service environment according to some implementations. The pod 244 may be used to render services to a user of the on-demand database service environment 200. In some implementations, each pod may include a variety of servers and/or other systems. The pod 244 includes one or more content batch servers 264, content search servers 268, query servers 282, file force servers 286, access control system (ACS) servers 280, batch servers 284, and app servers 288. Also, the pod 244 includes database instances 290, quick file systems (QFS) 292, and indexers 294. In one or more implementations, some or all communication between the servers in the pod 244 may be transmitted via the switch 236.

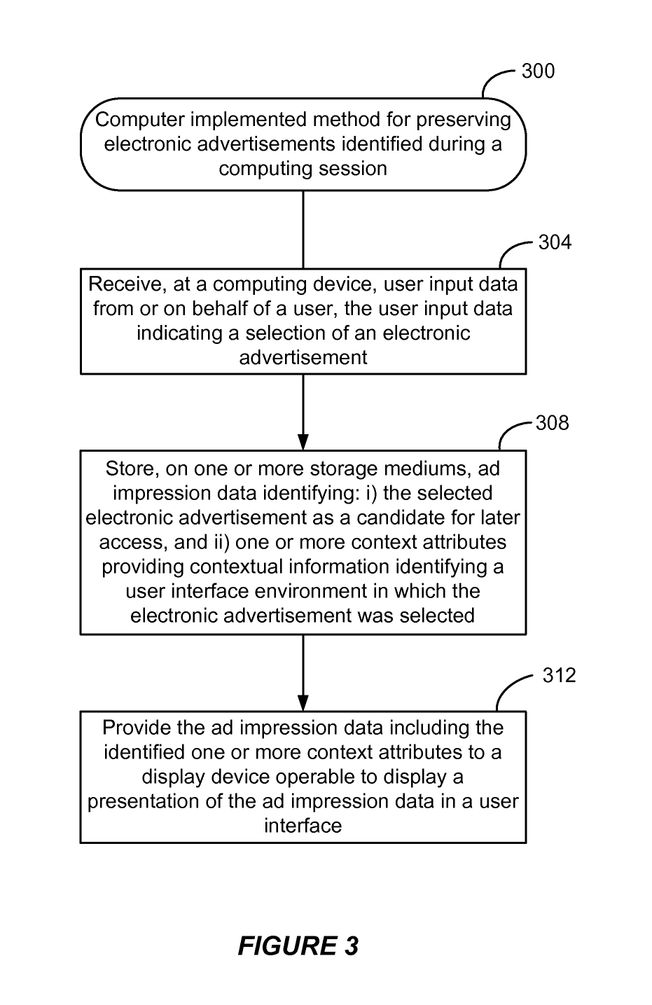

In some implementations, the app servers 288 may include a hardware and/or software framework dedicated to the execution of procedures (e.g., programs, routines, scripts) for supporting the construction of applications provided by the on-demand database service environment 200 via the pod 244. In some implementations, the hardware and/or software framework of an app server 288 is configured to execute operations of the services described herein, including performance of the blocks of methods described with reference to FIGS. 3-10. In alternative implementations, two or more app servers 288 may be included and cooperate to perform such methods, or one or more other servers described herein can be configured to perform the disclosed methods.

The content batch servers 264 may handle requests internal to the pod. These requests may be long-running and/or not tied to a particular customer. For example, the content batch servers 264 may handle requests related to log mining, cleanup work, and maintenance tasks.

The content search servers 268 may provide query and indexer functions. For example, the functions provided by the content search servers 268 may allow users to search through content stored in the on-demand database service environment.

The file force servers 286 may manage requests for information stored in the Fileforce storage 298. The Fileforce storage 298 may store information such as documents, images, and basic large objects (BLOBs). By managing requests for information using the file force servers 286, the image footprint on the database may be reduced.

The query servers 282 may be used to retrieve information from one or more file systems. For example, the query system 282 may receive requests for information from the app servers 288 and then transmit information queries to the NFS 296 located outside the pod.

The pod 244 may share a database instance 290 configured as a multi-tenant environment in which different organizations share access to the same database. Additionally, services rendered by the pod 244 may call upon various hardware and/or software resources. In some implementations, the ACS servers 280 may control access to data, hardware resources, or software resources.

In some implementations, the batch servers 284 may process batch jobs, which are used to run tasks at specified times. Thus, the batch servers 284 may transmit instructions to other servers, such as the app servers 288, to trigger the batch jobs.

In some implementations, the QFS 292 may be an open source file system available from Sun Microsystems® of Santa Clara, Calif. The QFS may serve as a rapid-access file system for storing and accessing information available within the pod 244. The QFS 292 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 268 and/or indexers 294 to identify, retrieve, move, and/or update data stored in the network file systems 296 and/or other storage systems.

In some implementations, one or more query servers 282 may communicate with the NFS 296 to retrieve and/or update information stored outside of the pod 244. The NFS 296 may allow servers located in the pod 244 to access information to access files over a network in a manner similar to how local storage is accessed.

In some implementations, queries from the query servers 222 may be transmitted to the NFS 296 via the load balancer 228, which may distribute resource requests over various resources available in the on-demand database service environment. The NFS 296 may also communicate with the QFS 292 to update the information stored on the NFS 296 and/or to provide information to the QFS 292 for use by servers located within the pod 244.

In some implementations, the pod may include one or more database instances 290. The database instance 290 may transmit information to the QFS 292. When information is transmitted to the QFS, it may be available for use by servers within the pod 244 without using an additional database call.

In some implementations, database information may be transmitted to the indexer 294. Indexer 294 may provide an index of information available in the database 290 and/or QFS 292. The index information may be provided to file force servers 286 and/or the QFS 292.

III. Tracking Updates to a Record Stored in a Database

As multiple users might be able to change the data of a record, it can be useful for certain users to be notified when a record is updated. Also, even if a user does not have authority to change a record, the user still might want to know when there is an update to the record. For example, a vendor may negotiate a new price with a salesperson of company X, where the salesperson is a user associated with tenant Y. As part of creating a new invoice or for accounting purposes, the salesperson can change the price saved in the database. It may be important for co-workers to know that the price has changed. The salesperson could send an email to certain people, but this is onerous and the salesperson might not email all of the people who need to know or want to know. Accordingly, some implementations of Chatter® can inform others (e.g., co-workers) who want to know about an update to a record automatically.

IV. Preserving Electronic Advertisements

FIG. 3 shows a flowchart of an example of a computer implemented method 300 for preserving electronic advertisements identified during a computing session, performed in accordance with some implementations. Electronic ads can be displayed in a wide variety of computing scenarios and environments. Ads can be stored in memory on a user's computing device, for instance, when an application executed on the device is configured to display the ad as part of a presentation in a GUI. Such applications can be configured to automatically retrieve ads from remote servers accessible over a communications network such as the Internet in response to certain events and/or actions during a user's interaction with the application. In other instances, ads can be retrieved from one or more servers by the user's computing device for display when the device is executing a web browser. That is, the browsing of various web sites and pages can cause ads to be displayed on those pages. Web browsers can be used to access various network-based services such as customer portals, public knowledge databases, and social networking systems. Any pages loaded in the user's browser when using such services can include ads.

For example, a social network such as Chatter® can provide access to various pages for a user to access various data. A user can access pages displaying various news feeds, a page showing the user's profile, record pages, group pages, community pages and others. When any of these various pages are loaded in the user's web browser, it can be desirable to display ads providing relevant content to the users, that is, where the content is related to the user's demonstrated actions and/or interests. For example, a group page in Chatter® may have been created for a group dedicated to germaphobes. Ads related to hand sanitizers can be displayed on such a group page based on the title, purpose, or content of the group page. When a user clicks on such an ad, information identifying the ad and identifying the group page on which it was displayed, as well as information identifying contemporaneous system events and user actions, can be stored and provided to the user when the user later visits the group page or otherwise accesses a designated web page or web site, as explained in greater detail below.

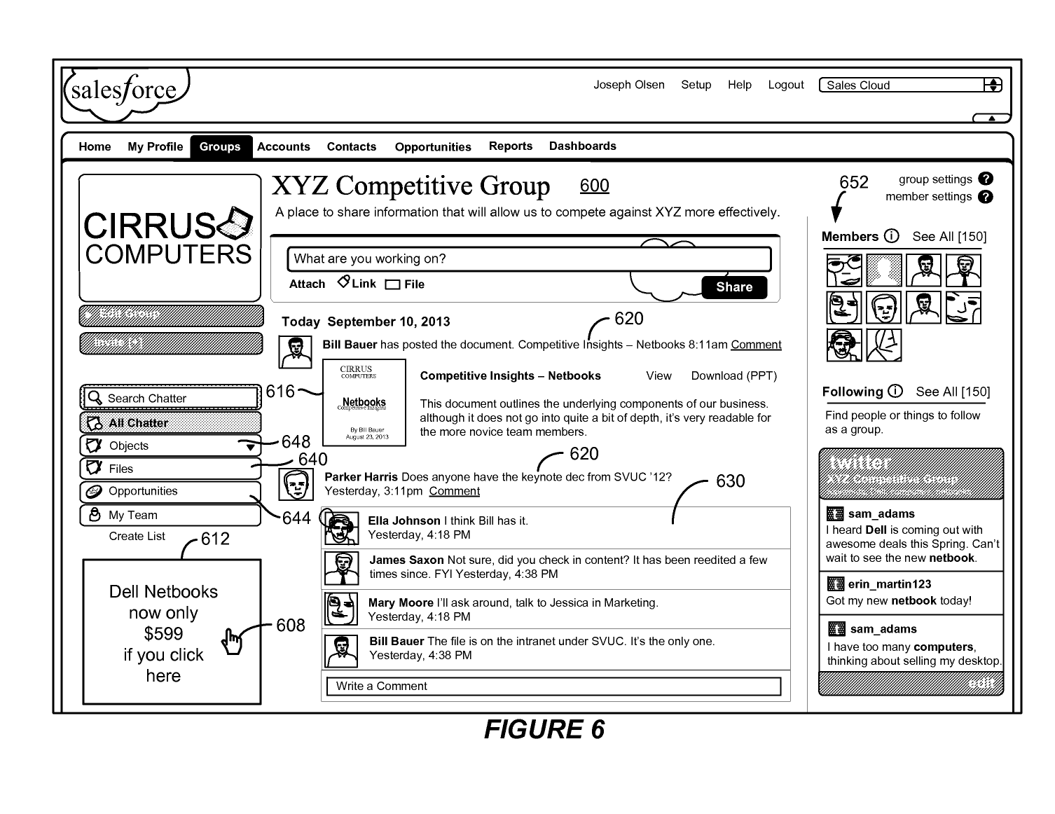

In FIG. 3, at block 304, a computing device such as a server is configured to receive user input data from or on behalf of a user. For example, in FIG. 6, a group page 600 of a social networking system such as Chatter® is displayed in the form of a GUI using a browser on a user's computing device such as a laptop or smartphone. In FIG. 6, when the user uses a pointing device such as a mouse to move a graphical pointer 608, the user can select a “Dell Netbooks” ad 612 by positioning pointer 608 over ad 612 and clicking a mouse button. The selection of ad 612 in this manner is communicated as a signal from the user's computing device to the server over the Internet. Thus, at block 304 of FIG. 3, the server receives user input data in the form of the user's selection of ad 612.

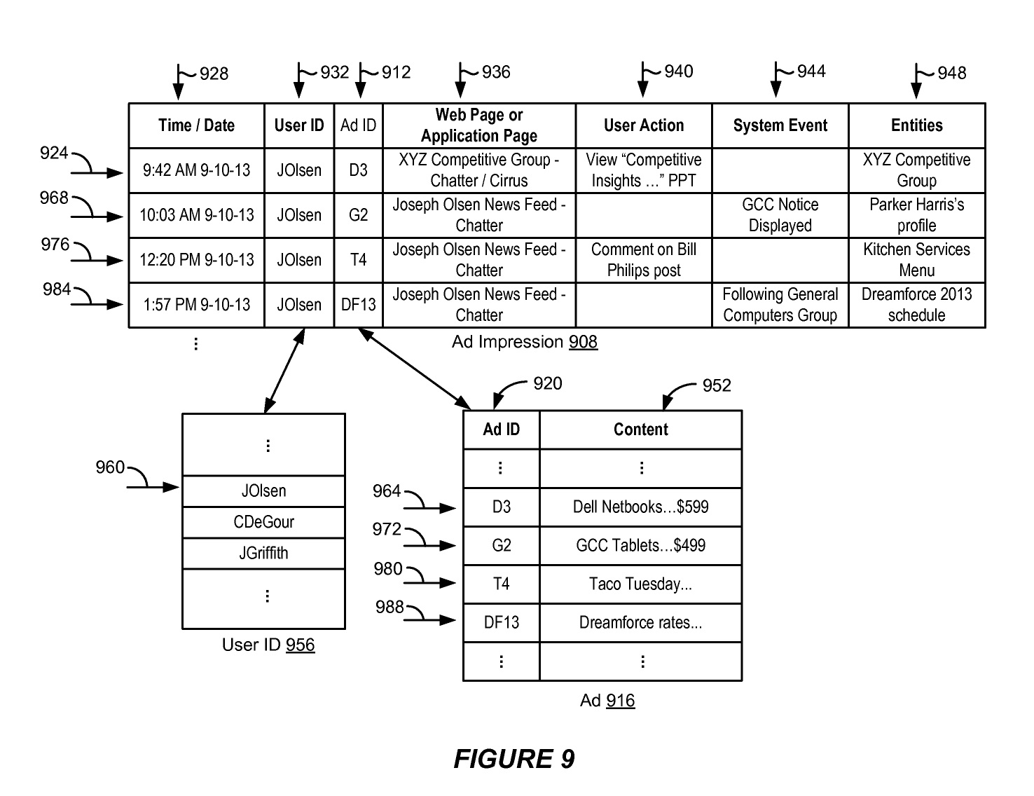

In FIG. 3, at block 308, in response to receiving user input data at block 304, ad impression data characterizing the user's selection of the ad can be stored on one or more storage mediums. For example, FIG. 9 shows an example of an arrangement of database tables described in greater detail below. In FIG. 9, an impression table 908 is maintained in a database that includes rows 924, 968, 976 and 984 each storing an ad impression representing a particular ad selection. The impression table 908 is configured to store ad IDs in a column 912. Each ad ID in column 912 identifies content of a selected advertisement in an ad table 916. That is, specific ad IDs in rows of column 912 point to corresponding ad IDs in column 920 of ad table 916.

At block 308 of FIG. 3, ad impression data identifies one or more context attributes characterizing a user interface environment such as the presentation of group page 600 in FIG. 6 when ad 612 was selected, by way of example. Thus, returning to FIG. 9, ad impressions in rows of impression table 908 each include a set of context attributes pertaining to a respective user state of a web page or application where an ad was selected. In the example of FIG. 6, context attributes pertaining to the user's selection of ad 612 are stored in row 924 of impression table 908. In this example, context attributes identified in columns of table 908 include a time and date in column 928, a user ID in column 932, an ad ID in column 912 as described above, a web page or application page in column 936, any identifiable user actions in column 940, any identifiable system events in column 944 and any identifiable entities in column 948. For example, the ad impression in row 924 of table 908 includes context attributes identifying the user's selection of ad 612 of FIG. 6 at 9:42 a.m. on Sep. 10, 2013 in column 928, the user ID “JOlsen” of a user, Joseph Olsen, who selected ad 612 in column 932, “D3” as an ad ID identifying ad 612 in column 912, the XYZ Competitive Group as the name of the page on which ad 612 was selected in column 936, accessible via Cirrus Computers' implementation of Chatter® as also identified in column 936.

In FIG. 9, a given row of table 908 is configured to store additional context attributes. For example, in the ad impression of row 924, several minutes before selecting ad 612, Joseph clicked on the “Competitive Insights—Netbooks” document 616 attached to Bill Bauer's post 620 of FIG. 6. The selection of document 616 was identified as a user action in temporal proximity to Joseph's selection of ad 612 and, thus, identified in column 940 of table 908 in FIG. 9. Various system events in temporal and/or special proximity to an ad selection, such as the updating of a page to include new data or performance of a scheduled batch job, can be identified in column 944. In the example of row 924, no such system events have been detected. Various entities can also be identified as context attributes of an ad impression. In the example of row 924, in column 948, the XYZ Competitive Group has been identified as one entity of possible relevance to the selection of ad 612, because Joseph viewed ad 612 on the XYZ Competitive Group page 600.

In FIG. 9, column 936 is configured to store one or more attributes identifying a web page, web site, display screen presentation of an application, or other user interface in which an ad was selected. Thus, table 908 can be used in implementations in which ads are displayed via local applications executed on the user's device. Information identifying the particular graphical presentation of the application on which an ad was displayed and selected can be transmitted from the user's device to a server performing method 300. Part or all of the ad content can also be transmitted from the user's device to the server performing method 300 for storage in column 952 of ad table 916, that is, referenced by a particular ad ID in column 920.

In FIG. 9, a user ID table 956 stores various user IDs of users whose selections of ads are being monitored. In this example, column 932 of impression table 908 is configured to look up to user ID table 956 to identify, for example, JOlsen in row 924 as the ID of one of a number of users of Chatter® identified in field 960 of user ID table 956, by way of example. Thus, by identifying the user ID in column 932 and the ad ID in column 912 of table 908 for a given ad impression, such as row 924, ad IDs can be used to retrieve the appropriate content from column 952 of ad table 916 for delivery to a device operated by a user having the user ID as maintained in table 956. One or more servers implementing method 300 can cooperate to make queries to tables 908, 916 and 956 to retrieve and deliver the appropriate data when desired, as explained in greater detail below.

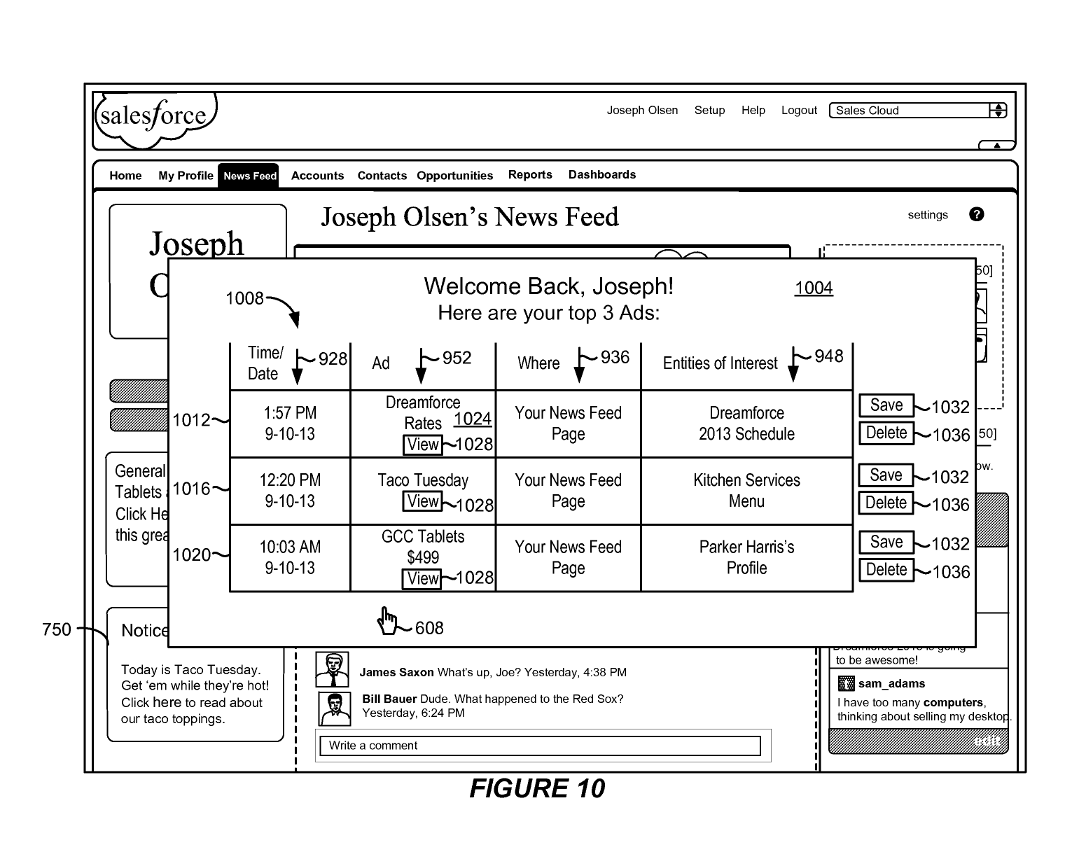

Returning to FIG. 3, at block 312, at some time after one or more ads have been selected and appropriate ad impression data stored, as described above at blocks 304 and 308, packages of ad impressions can later be retrieved and delivered to a user's device to display one or more context attributes of each selection. For example, FIG. 10 shows a pane 1004 in the form of a GUI including a list 1008 of ad impressions and related data retrieved from one or more of the database tables of FIG. 9. In FIG. 10, when Joseph later accesses a page at which an ad was selected, that user action can trigger the delivery of list 1008 including selected context attributes of one or more ad impressions retrieved from impression table 908 of FIG. 9 as well as ad content retrieved from column 952 of ad table 916. In this example, pane 1004 overlays Joseph's news feed page.

At block 312 of FIG. 3, a truncated selection of context attributes stored in impression table 908 can be desirable when the user's computing device is a smartphone, tablet or other type of portable handheld device where screen real estate may be limited. Thus, in the example of FIG. 10, only selected context attributes determined to be most relevant to triggering the user's memory of the environment in which the ad was selected include time and date information in column 928, “where” information matching the data stored in column 936 of table 908, and entities of interest identified in column 948. Ad content in column 952 of ad table 916 is also included in list 1008.

Returning to FIG. 9, tables 908, 916 and 956 can be maintained on any of a variety of storage mediums as disclosed herein. For instance, tenant data storage 22 and/or system data storage 24 of FIGS. 1A and 1B can be configured to maintain the data of tables 908, 916 and 956. Any of the various databases and/or memory devices described herein can serve as storage media to implement database tables 908, 916 and 956.

In FIG. 3, in one example, an app server 288 in the on-demand service environment 200 of FIGS. 2A and 2B includes one or more processors configured to perform part or all of blocks 304-312. In other instances, one or more other computing devices such as a user system 12 of FIGS. 1A and 1B, e.g., in the form of a user's smartphone, is configured to retrieve, process, and exchange data to cooperate with app server 288 to perform the blocks of method 300. User input data, for example, can be received by a server over a communications network from a user operating a user system 12 as shown in FIGS. 1A and 1B. In other instances, such data is received from a proxy server on behalf of a user. Various implementations of method 300 are possible, such that any one or more of the servers described above with reference to FIGS. 1A, 1B, 2A and 2B can be configured to process data to perform part or all of method 300.

At block 312 of FIG. 3, by way of example, the ad impression data is transmitted from a server such as app server 288 over network 14 to a user system 12 of FIGS. 1A and 1B. In this example, user system 12 includes a processor configured to execute a browser stored on user system 12 to output a graphical presentation of the ad impression data on a display of user system 12, for instance, in a GUI. In other examples, the data provided at block 312 is generated locally at user system 12. By the same token, in some implementations, one or more of blocks 304-312 as described above can be performed at user system 12 as an alternative to being performed at one or more servers. The same is generally true for the other examples of methods described below.

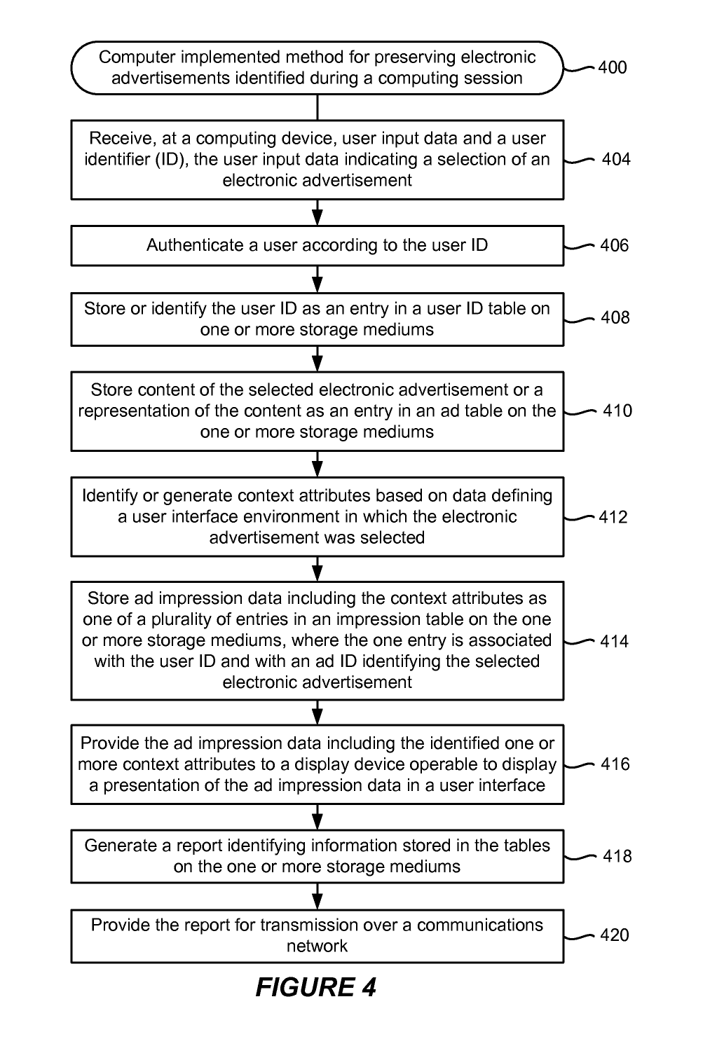

FIG. 4 shows a flowchart of an example of a computer implemented method 400 for preserving electronic advertisements identified during a computing session, performed in accordance with some implementations. At block 404, a computing device such as a server is configured to receive user input data as described above at block 304 of method 300. At block 404, the server also receives a user identifier (ID), which identifies a user. For example, the user ID can be in the form of a user's login credentials transmitted to a server for accessing any social network or other network-based service such as Chatter®. In another example, the user ID can be stored at a user's computing device in connection with the user's browser or in connection with an application installed on the user's device. The user ID can alternatively be stored on the user's device to identify the device itself.

At block 406, a user ID received at block 404 is authenticated using any of a variety of security protocols. For example, authentication techniques used to authenticate a user when logging into Chatter® can be performed at block 406. At block 408, the user ID received at block 404 can be stored or identified in a user ID table on a database. For example, returning to FIG. 9, user ID table 956 is configured to store user IDs of users whose interactions with ads are being monitored. Thus, when the user ID authenticated at block 406 of FIG. 4 is not in user ID table 956, the user ID can be stored as an entry in table 956. In other examples, when the user ID is already in table 956, a table lookup can be performed to identify the authenticated user ID from block 406 in table 956. In some instances, a previous user ID in table 956 can be updated to link the previous ID with a later ID received from the same user when using a different application or web-based service.

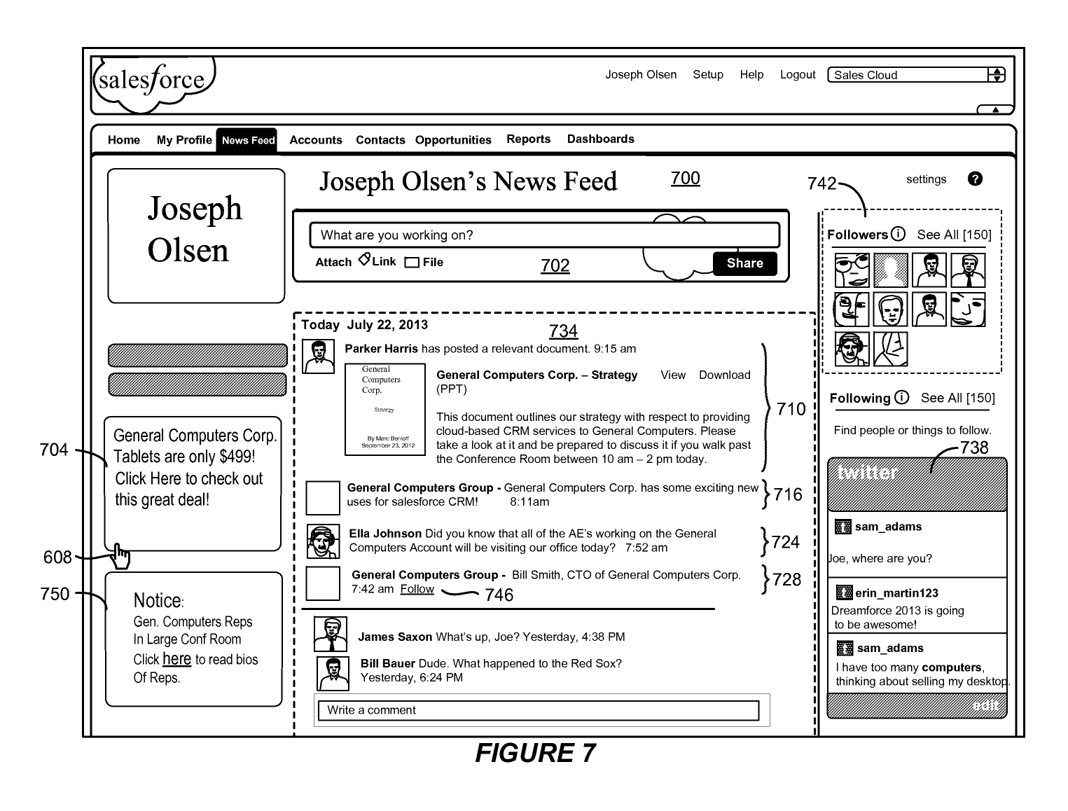

FIG. 7 shows an example of a presentation 700 of a news feed page in the form of a GUI as displayed on a user's computing device, in accordance with some implementations. In the example of FIG. 7, a user, Joseph Olsen, has logged in to Chatter® to view his news feed page. When Joseph maneuvers his pointer 608 over a General Computers Corp. (GCC) ad 704, and clicks on ad 704, Joseph's user ID used to log in to Chatter®, “JOlsen” in this example, can be identified in field 960 in user ID table 956. Thus, if Joseph's user ID has already been stored in table 956, for example, after previously clicking on ad 612 of FIG. 6, his user ID in field 960 of table 956 can be linked with any number of ad impressions stored in an impression table 908 in this example.

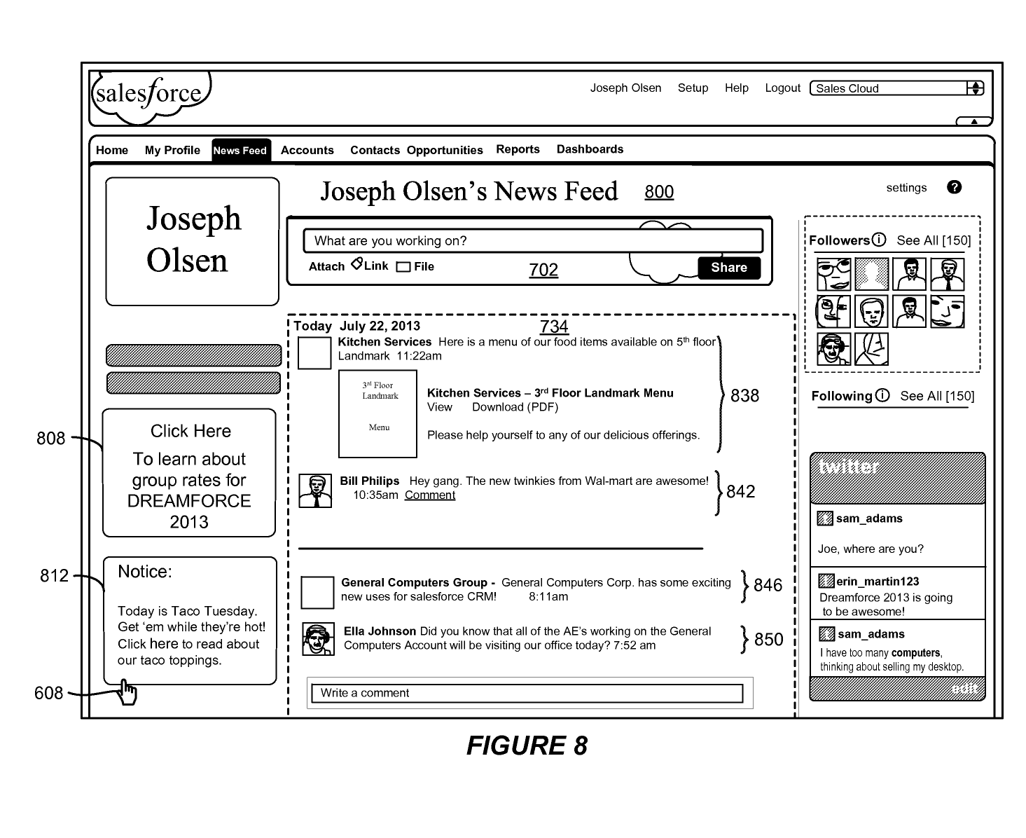

FIG. 8 shows an example of an updated presentation 800 of the news feed page of FIG. 7 as displayed on a user's computing device, in accordance with some implementations. As shown in FIG. 8, when Joseph accesses his news feed at a different time, such as later in the day after viewing presentation 700 of FIG. 7, different advertisements can be displayed. In the example of FIG. 8, ad 704 of FIG. 7 has been replaced with an ad 808 regarding rates for attending the Dreamforce event in 2013. In addition, presentation 800 also includes an ad 812 regarding tacos being served in the kitchen of the office in which Joseph works. Thus, at block 410 of FIG. 4, when Joseph maneuvers pointer 608 over ads 808 and 812, selection of those ads causes tables 908 and 916 to be updated as generally described above.

In FIG. 4, at block 410, selections of various ads during the same or different computing sessions cause ad table 916 of FIG. 9 to be updated with content or representations of content of the selected ads. Thus, in the example of FIGS. 6-8, Joseph's selection of ad 612 in FIG. 6 causes row 924 to be generated and stored in impression table 908 as well as a corresponding entry 964 in table 916 with an ad ID, “D3” in column 920, identifying ad 612 and a portion of the text of ad 612, “Dell Netbooks . . . $599” in the content column 952. Later in the day when Joseph clicks on ad 704 of FIG. 7, row 968 is generated and stored in impression table 908 as is corresponding entry 972 in ad table 916. Again, in columns 912 and 920 of tables 908 and 916, an ad ID “G2” identifies GCC ad 704 of FIG. 7, and a content field of entry 972 in table 916 includes part of the text of ad 704, “GCC tablets . . . $499”. When Joseph later logs back in to Chatter® to view presentation 800 of FIG. 8 and clicks on ad 812, row 976 is generated and stored in impression table 908 of FIG. 9 and linked with entry 980 of ad table 916 with an ad ID “T4” identifying ad 812 of FIG. 8 and with at least a portion of the ad content, “Taco Tuesday”, stored in content column 952. When Joseph then clicks on ad 808 in FIG. 8, row 984 is generated and stored in impression table 908 of FIG. 9, and entry 988 is stored in ad table 916. The ad ID “DF13” links row 984 and entry 988 in columns 912 and 920 of tables 908 and 916, and a content field of entry 988 includes keywords from ad 808, “Dreamforce rates.”

Those skilled in the art should appreciate that while keywords or portions of the text of ads are stored in the example of ad table 916 in FIG. 9, other various ad content or representations of ad content including icons, thumbnail images, screen captures, hyperlinks, audio data and video data can also or alternatively be stored in content column 952 of table 916.

Returning to FIG. 4, at block 412, context attributes providing contextual information identifying a user interface environment in which an ad was selected are identified or generated. These context attributes are generally described above at block 308 of method 300. At block 412 of FIG. 4, one or more context attributes are identified or generated based on data defining the user interface environment. In some implementations, state data defining the state of a page viewed in the user's web browser can be identified or generated. For example, part or all of the URL at which the XYZ Competitive Group page of FIG. 6 is accessed can be identified. Such information can identify the web site and a particular page on which an ad is displayed. Various types of web pages on which ads are displayed can be identified as context attributes at block 412, such as a news feed page, a user's profile page, a record page, a group page, or a community page in a social networking system.

Other various context attributes can be identified and/or generated at block 412. For example, part or all of the content of a web page can be captured as an attribute. Thus, in the example of FIG. 6, the name of the group, “XYZ Competitive Group”, can be identified as well as any of the various posts and comments in a feed. Portions of content displayed on Joseph's news feed page of FIG. 7 such as feed items 710-728 in feed region 734 can be captured as context attributes, as can the content or visual presentation of a portion of Joseph's Twitter® feed in region 738 displayed as a component of Joseph's news feed page 700. In FIG. 8, feed region 734 includes a different set of feed items 838-850, some or all of which can be captured as described above. By the same token, part or all of the presentation of a publisher as well as at least a portion of content entered into publisher 702 as displayed in the presentations of FIG. 7 or 8 can be captured as a context attribute associated with the selection of ads 704, 808 and 812 when displayed on Joseph's news feed page.

Other examples of context attributes include entities associated with a web page or web site on which a selected ad was displayed. For example, in FIG. 6, XYZ Competitive Group can be identified as the subject of page 600 on which ad 612 was displayed. Other entities such as users Bill Bauer and Parker Harris having posted to the group feed on page 600 can be identified as entities. In addition, entities such as uploaded document 616, post 620, comments 630, group files identified using tab 640, opportunities at tab 644, customer objects listed under tab 648 and group members in region 652 can be identified as entities associated with ad 612. The type of such an entity can similarly be identified as a context attribute, such as user, record, group, community, custom object, as well as contact, lead, opportunity, account, deal, case, contract or other type of CRM object.

Other context attributes include the identity of an application executed locally on a user's computing device having a graphical presentation on which an ad or a link to an ad is displayed. For example, game software, accounting software, word-processing software and other various programs executable on a user's computing device can be configured to display ads at designated times or in response to designated events. By the same token, the identities of specific pages, graphical presentations, or regions of graphical presentations displayed on a user's device when an application is executed can be identified as context attributes of the ad. Portions of content of such graphical presentations can also be captured as explained above in the examples of FIGS. 6-8. Entities associated with an application can also be identified as context attributes, such as the maker of a given application or provider of any files, data, or objects linked with or identified by the application.

Other examples of context attributes, regardless of whether the ad is displayed on a web page or displayed locally using an application on the user's device, include the identity of the user selecting the ad as well as any role, title, status or other characterization of the user often accessible through a user profile. Thus, in some instances, a user profile in a social network such as Chatter® or Facebook® can be accessed following the selection of an ad to retrieve more information identifying the particular user selecting the ad. Other types of context attributes that can be identified and generated at block 412 of FIG. 4 include user actions in temporal or spatial proximity to the selection of an ad. For example, a user may have submitted a post using publisher 702 of FIGS. 7 and 8 within several minutes before or after selecting ad 704 or ads 808 and 812.

Other actions occurring during the same computing session or within a designated time window of the selection of an ad can include clicking on any component of the page, entering data in a textbox, selecting an item from a pick list, as well as user actions in other tabs of a browser, such as the selection of an email application or sending of an instant message (IM) or tweet. In some instances, the spatial proximity of a user action to the location of an ad displayed on a page can be a factor for determining a context attribute. For example, in FIG. 7, user actions taken in feed region 734, such as clicking on any of the posts in region 734, can be identified, while the use of publisher 702 or selection of Twitter® feed 738 can be discarded for consideration as context attributes.

Other context attributes that can be identified include system events in temporal proximity to the selection of an ad, such as the pushing of one or more feed items to the feed in FIGS. 7 and 8, any notifications of calendared items, the updating of Twitter® feed 738, or updating of identified followers in region 742 of presentation 700. Other context attributes include entities with which a user is communicating in temporal proximity to the selection of an ad, such as Parker Harris when Joseph comments on Parker's post 710 or General Computers Group which Joseph follows by clicking on link 746 on the same day as or in the same computing session as clicking on ad 704 by way of example. Any role, title, status, or action of such entities such as users, records, CRM objects, groups and communities can similarly be identified as context attributes. Also any relationships of such entities to a user such as Joseph Olsen can be identified as a context attribute. For example, when Joseph is following the General Computers Group, that following relationship can be identified. By the same token, any friend relationships between Joseph and another user in a social networking system can be similarly identified as context attributes. Also, the lack of existence of such a relationship can be identified as a context attribute at block 412 of FIG. 4.

In FIG. 4, at block 414, ad impression data including any context attributes as described above with respect to block 412 is stored as a row in impression table 908 of FIG. 9 as mentioned above. In the example of FIG. 9, each row 924, 968, 976 and 984 corresponds to the selection of an ad by Joseph Olsen over time on the presentations of FIGS. 6-8 as described above. Thus, in this example, during part of a day, Joseph selected ad 612 of FIG. 6 at 9:42 a.m., ad 704 of FIG. 7 at 10:03 a.m., ad 812 of FIG. 8 at 12:20 p.m., and ad 808 of FIG. 8 at 1:57 p.m., as identified in time and date column 928.

As mentioned above, columns 936-948 provide selected context attributes associated with each selection. Thus, in row 968, when Joseph selected ad 704 of FIG. 7, Joseph's news feed page as well as the social network which Joseph accessed, Chatter® in this example, are identified in column 936. In row 968, a system event, in this example, the display of a notice 750 in FIG. 7, is identified as being displayed at the same time as ad 704 was selected on that page. In this example, Parker Harris's profile is identified as an entity of interest in column 948, since Parker's post 710 was displayed at the top of Joseph's feed in region 734 of FIG. 7. In another example, Parker Harris's profile may have been identified in column 948 of FIG. 9 when Joseph commented on Parker's post during the same computing session as when Joseph selected ad 704.

In another example, in row 976 of FIG. 9, Joseph's selection of the Taco Tuesday ad 812 is linked with the action in column 940 of Joseph commenting on Bill Phillips' post 842 using publisher 702 as an action preceding or following the selection of ad 812. In this example, the selection of ad 812 is also linked with an entity in column 948 in the form of the Kitchen Services menu published to Joseph's news feed as part of a feed item 838 during the presentation of ad 812. In the example of Joseph selecting the Dreamforce ad 808 at 1:57 p.m., in row 984 of FIG. 9, Joseph's subscription to follow the General Computers Group using link 746 in FIG. 7 on the same day as the selection of ad 808 is identified as a system event in column 944. In this example, in row 984, a document title “Dreamforce 2013 Schedule” is not displayed in Joseph's user interface but is nonetheless identified as an entity linked with the selection of ad 808 in column 948 due to the determined relevance of the Dreamforce 2013 Schedule to Dreamforce ad 808.

In FIG. 9, while impression table 908 shows only certain context attributes of interest in this example, other implementations of impression table 908 can include columns identifying any of the various context attributes disclosed herein. For instance, additional columns in an alternative version of impression table 908 can include the identities of any database records, custom objects, CRM objects, user profiles, groups, and communities identifiable in relation to the selection of an ad displayed on a graphical presentation of an application or a page during a computing session.

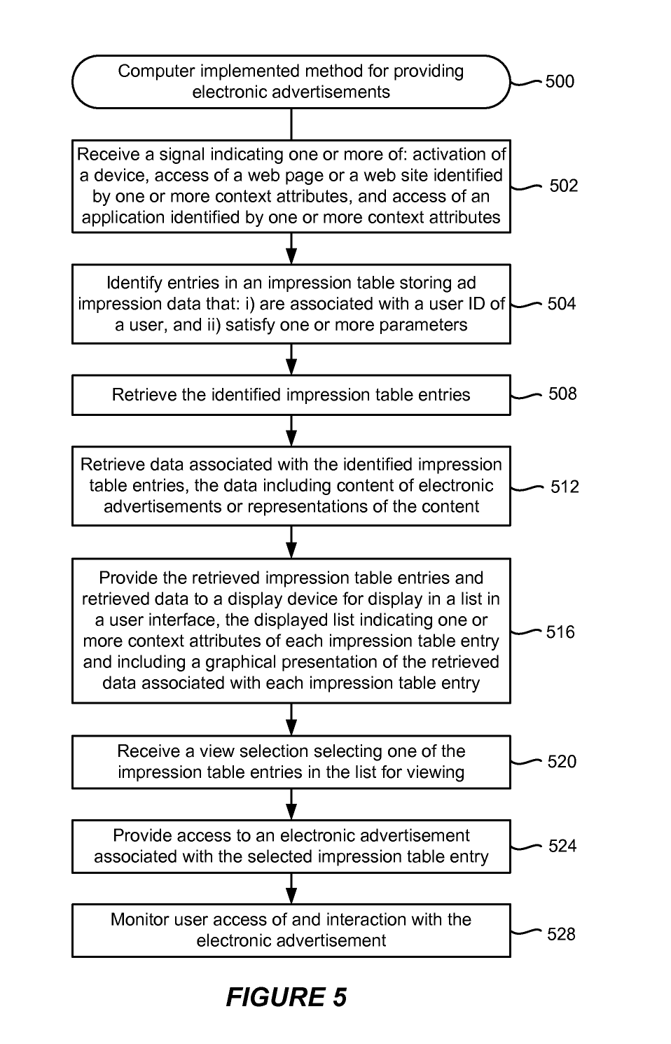

Returning to FIG. 4, at block 416, after storing one or more entries in tables such as those shown in FIG. 9, part or all of the data can be retrieved and delivered to a user's device for later access. For example, when a server detects that Joseph Olsen has requested such data or accessed a page on which one of the ads was displayed when selected, any rows in table 908 identifying Joseph's user ID in column 932 can be retrieved by a server in communication with impression table 908 and delivered to Joseph's computing device for display in a list. As explained in greater detail below with respect to FIGS. 5 and 10, any of various context attributes can be retrieved from table 908 and delivered to provide Joseph with a summary of ads which he previously selected.

At block 418 of FIG. 4, an electronic report can be generated identifying data of interest that is stored in an impression table 908 or in any other tables associated with table 908. For example, advertisers may be interested in which ads were most popular, which users selected which ads, what categories or types of users were interested in particular ads, as well as the forums on which the ads were displayed. Thus, using tables such as impression table 908, user ID table 956, and ad table 916, at block 418, a report can cluster ad impressions associated with a particular ad ID in column 912, ad impressions associated with a particular user ID in column 932, any ads having been selected to cause a row in impression table 908 to be generated, the identities of any user IDs in column 932, the identities of any ads selected by a user having a specific user ID in table 956, and the identities of web pages, web sites, and applications in column 936 where ads of interest were displayed.

In FIG. 4 at block 420, such a report generated at block 418 can be printed using a printing device or transmitted as an electronic document from one computing device to another, for example, from a server maintained by a provider responsible for performing method 400 to a server or desktop computer operated by an advertiser or marketing specialist.

FIG. 5 shows a flowchart of an example of a computer implemented method 500 for providing electronic advertisements, performed in accordance with some implementations. At block 502, any of a variety of events can trigger the retrieval of ad impressions stored as entries in an impression table as described above for delivery to a display device to be viewed by a user. For example, the activation of the user's device by, for example, waking up the device when it is in sleep mode or powering on the device can be communicated to a server performing method 500. In another example, when the user accesses a designated web page or web site identified by one or more context attributes, as described above, such an event can be communicated to the server at block 502. Thus, when the XYZ Competitive Group page 600 of FIG. 6 or Joseph Olsen's news feed page of FIGS. 7 and 8 is marked as a page to trigger the retrieval of ad impressions, the act of Joseph loading such a page on his smartphone can be communicated to the server at block 502. In another example, a user's access of a network-based service such as Facebook®, Twitter®, or Chatter®, by way of example, can be communicated to the server at block 502. In another example, a local application installed on a user's device can cause impression table entries to be retrieved. That is, execution of the application or the display of one or more graphical presentations of the application can trigger the retrieval of impression table entries.

In FIG. 5, in response to receiving a signal indicating one or more events as described above with reference to block 502, at block 504, relevant entries in an impression table as described above can be identified. In some instances, any ad impressions stored in association with a given user ID are identified at block 504. Returning to the example of FIG. 9, rows 924, 968, 976 and 984 can be retrieved at block 504 of FIG. 5 as all being associated with the user ID “JOlsen”. Those skilled in the art will appreciate that the particular user ID to identify rows in impression table 908 can be communicated to the server as part of the signal sent from a user's device to a server at block 502.

At block 504, in some implementations, relevant entries in an impression table are further filtered according to one or more parameters. In some implementations, parameter-based filtering is performed independent of any identification of impression table entries according to a particular user ID. In some other implementations, impression table entries are filtered according to both a user ID and one or more parameters. One or more of various parameters can be applied at block 504. For example, a parameter can specify a time window during which impression table entries were stored. Thus, returning to the example of FIG. 9, when the time window is set at 24 hours, and Joseph accesses his news feed page at 8:00 p.m. on Sep. 10, 2013, all of rows 924, 968, 976 and 984 in impression table 908 would be retrieved. Alternatively, when such a time window is set at 6 hours, and Joseph accesses his news feed page at 5:00 p.m. on September 10th, only rows 976 and 984 of table 908 would be retrieved.

At block 504, another example of a parameter is the number of times an ad identified by impression table entries has been accessed. A count can be maintained on one or more servers, for instance, each time a user clicks on the ad. For example, a minimum number of times of access can be specified as 100 clicks on the ad. Thus, only ads having been clicked on at least 100 times would be identified at block 504. In some instances, a frequency of access can be applied at block 504. Thus, only ads accessed a minimum number of times during a specified time window would be identified. For example, a frequency of access can specify that only ads accessed 50 times during a 4-hour window are identified.

In FIG. 5, at block 508, any impression table entries identified at block 508 are retrieved by a server performing or cooperating to perform method 500. At block 512, in some implementations, additional data is retrieved. For example, at least a portion of the content of the ad identified by an ad impression or a representation of such content can be retrieved from ad table 916 of FIG. 9. That is, in this example, when rows 924, 968, 976 and 984 are retrieved from impression table 908, those rows look up to corresponding entries 964, 972, 980 and 988 of ad table 916 by virtue of ad IDs in column 912 of impression table 908 pointing to ad IDs of column 920 of ad table 916. Thus, any data stored in fields of content column 952 of ad table 916 can be retrieved. Various other database table configurations are possible to store and retrieve appropriate content, as will be appreciated by those skilled in the art.

In FIG. 5, at block 516, ad impressions and any corresponding data such as ad content retrieved at blocks 508 and 512 can be delivered from a server performing method 500 to a user's device for display in an appropriate presentation in a GUI. For example, in FIG. 10, retrieved impression table entries are organized and presented in list 1008 in pane 1004. In this example, only rows 968, 976 and 984 of impression table 908 of FIG. 9 were identified as satisfying one or more parameters at block 504, as described above. Identified entries are presented in list 1008 in reverse chronological order as items 1012, 1016 and 1020 in this example. That is, item 1012 corresponds to row 984 of impression table 908, item 1016 corresponds to row 976 of table 908, and item 1020 corresponds to row 968 of table 908.

As mentioned above, ad content or representations of content stored in column 952 of ad table 916 in FIG. 9 can be inserted with each item 1012-1020 in list 1008. Thus, for example, since row 984 of impression table 908 is linked with entry 988 in ad table 916, the content of entry 988 can be presented in field 1024 of item 1012 in FIG. 10. Various additional context attributes such as those stored in columns 936 and 948 of impression table 908 of FIG. 9 can be presented in matching columns in list 1008 of FIG. 10.

In pane 1004 of FIG. 10, when a list of items of interest is displayed to a user, a user can navigate graphical pointer 608 over any of the various ads identified in column 952. In this example, each field of column 952 in pane 1004 includes a view button 1028, which the user can click on to load a more complete presentation of the ad of interest. In some implementations, clicking on a view button 1028 can cause additional content stored in column 952 of ad table 916 to be retrieved. In other instances, clicking on a view button 1028 can cause a URL at which the ad was originally presented to be loaded in the user's web browser. In other implementations, for example, when the ad was originally displayed on a first page as a link which a user could click through to access a second page at a different URL, the second page can be loaded in response to clicking on view button 1028. Thus, at block 524 of FIG. 5, access to the particular ad of an item in list 1008 can be provided when a user clicks on the content displayed in a particular field of column 952 or a view button 1028.

In FIG. 5, at block 528, user access of particular ads displayed in a list such as list 1008 of FIG. 10 can be monitored. For example, a count can be maintained for each time a user clicks through to a particular ad using, for example, a view button 1028 as described above. In this way, the popularity of ads for a particular user as well as an overall popularity regardless of user can be monitored. By the same token, additional monitoring of a user's interaction with an ad can be achieved. For example, when a user clicks through to access an ad as displayed in the list of pane 1004, additional selections and/or inputs by the user with the ad in the environment of a page displayed on the user's device can be tracked.

Additional examples of monitored interaction with a particular ad can be in the form of saving of deleting items in list 1008. For example, each item 1012, 1016 and 1020 has a corresponding save button 1032 and delete button 1036. When a user clicks on save button 1032 of a particular item, that action selects the corresponding impression table entry for further storage. For example, in impression table 908 of FIG. 9, an additional column can be provided to mark selected ad impressions for storage for an indefinite amount of time or some additional amount of time than would normally be permitted. In some systems it may be desirable to purge rows of impression table 908 within 48 or 72 hours of being added to table 908. In such instances, clicking on save button 1032 can cause selected rows in impression table 908 to be stored for an additional 48 hours or an indefinite amount of time, according to the desired implementation. As part of the monitoring of block 528 of method 500, the particular ads of items marked to be saved using save button 1032 can be tracked for marketing analysis. For example, such ads can be identified as having a significant impact on the particular user or on a particular demographic to which the user belongs.

By the same token, clicking on delete button 1036 of a particular item of list 1008 can cause the corresponding row of impression table 908 in FIG. 9 to be marked for deletion at the next scheduled time or to be immediately deleted, in various implementations. As with the saving of particular items in pane 1004, the deletion of particular items in pane 1004 can similarly be monitored. That is, the ad of an item marked for deletion can be identified as having a negative impact on the user or a group of users, and various additional marketing analyses can be performed on such data.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer implemented method for preserving electronic advertisements identified during a computing session, the method comprising:
receiving, at a computing device, user input data from or on behalf of a user, the user input data indicating a selection of an electronic advertisement;
causing to be stored, on one or more storage mediums, ad impression data identifying:
i) the selected electronic advertisement as a candidate for later access, and
ii) one or more context attributes providing contextual information identifying a user interface environment in which the electronic advertisement was selected; and
providing the ad impression data including the identified one or more context attributes to a display device operable to display a presentation of the ad impression data in a user interface.

2. The method of claim 1, wherein storing the ad impression data includes:
storing the ad impression data as one of a plurality of entries in an impression table on the one or more storage mediums, the one impression table entry being associated with a user identifier (ID) identifying the user and being associated with an ad ID identifying the selected electronic advertisement.

3. The method of claim 2, further comprising:
generating a report identifying one or more of: impression table entries associated with a respective electronic advertisement, impression table entries associated with a respective user ID, electronic advertisements associated with respective impression table entries, user IDs associated with respective impression table entries, electronic advertisements associated with respective user IDs, and web pages or web sites on which respective electronic advertisements are displayed; and
providing the report for transmission over a communications network.

4. The method of claim 2, wherein the user ID is stored as one of a plurality of entries in a user ID table on the one or more storage mediums, each user ID table entry identifying a user, and the ad ID is stored as one of a plurality of entries in an ad table, each ad table entry identifying an electronic advertisement.

5. The method of claim 1, wherein the ad impression data is stored in association with one or more of: a database record, a custom object, a customer relationship management (CRM) object, a user profile, a group, and a community.

6. The method of claim 1, further comprising:
storing or updating a user ID as an entry in a user ID table on the one or more storage mediums, the user ID table entry being stored in association with the ad impression data.

7. The method of claim 6, further comprising:
receiving the user ID at the computing device, the user ID being associated with an application or with a network-based service accessed by the user; and
authenticating the user according to the user ID.

8. The method of claim 1, further comprising:
storing content of the selected electronic advertisement or a representation of the content as an entry in an ad table on the one or more storage mediums, the ad table entry being stored in association with the ad impression data.

9. The method of claim 1, further comprising:
identifying or generating the one or more context attributes based on data defining the user interface environment.

10. The method of claim 1, wherein the context attributes identify one or more of: a web site on which the electronic advertisement was displayed, a web page on which the electronic advertisement was displayed, a web page on which a link to the electronic advertisement was displayed, at least a portion of content of a web page, an entity associated with a web page or a web site on which the electronic advertisement was displayed, a type of entity associated with a web page or a web site on which the electronic advertisement was displayed, an application having a graphical presentation on which the electronic advertisement was displayed, an application having a graphical presentation on which a link to the electronic advertisement was displayed, one or more graphical presentations of an application displaying the electronic advertisement or displaying a link to the electronic advertisement, at least a portion of content of a graphical presentation associated with an application, an entity associated with the application, a time at which the electronic advertisement was selected, a date on which the electronic advertisement was selected, an identity of the user, a role of the user, a title of the user, a status of the user, an action of the user in temporal or spatial proximity to the selection, a type of action of the user in temporal or spatial proximity to the selection, a system event in temporal proximity to the selection, an entity with which the user was communicating in temporal proximity to the selection, a role of an entity with which the user was communicating in temporal proximity to the selection, a title of an entity with which the user was communicating in temporal proximity to the selection, a status of an entity with which the user was communicating in temporal proximity to the selection, a relationship of the user with an entity, and a lack of existence of a relationship of the user with an entity.

11. The method of claim 10, wherein the web page is a social network page in the form of one of: a news feed page, a user's profile page, a record page, a group page, and a community page.

12. The method of claim 1, further comprising:
identifying entries in an impression table storing ad impression data as being associated with a user ID of the user and as satisfying one or more parameters;
retrieving the identified impression table entries;
retrieving data associated with the identified impression table entries, the data including content of electronic advertisements or representations of the content;
providing the retrieved impression table entries and retrieved data to the display device for display in a list in the user interface, the displayed list indicating one or more context attributes of each impression table entry and including a graphical presentation of the retrieved data associated with each impression table entry.

13. The method of claim 12, further comprising:
receiving an indication of one or more of: activating the display device, accessing a web page or a web site identified by the one or more context attributes, and accessing an application identified by the one or more context attributes.

14. The method of claim 12, wherein the parameters specify one or more of: a time window during which the impression table entries were stored and a frequency of access of electronic advertisements associated with the impression table entries.

15. The method of claim 12, further comprising:
receiving a view selection selecting one of the impression table entries in the list for viewing;
providing access to an electronic advertisement associated with the selected impression table entry; and
monitoring user access of the electronic advertisement.

16. The method of claim 12, further comprising:
receiving a deletion selection selecting one or more of the impression table entries in the list for deletion;
deleting the selected one or more impression table entries from the impression table; and
monitoring user deletion of the one or more impression table entries.

17. The method of claim 12, further comprising:
receiving a save selection selecting one or more of the impression table entries in the list for further storage;
marking the selected one or more impression table entries in the impression table for further storage; and
monitoring user selection of the one or more impression table entries.

18. The method of claim 1, wherein the display device is a portable handheld device.

19. One or more computing devices for preserving electronic advertisements identified during a computing session, the one or more computing devices comprising:
one or more processors operable to execute one or more instructions to:
receive, at a computing device, user input data from or on behalf of a user, the user input data indicating a selection of an electronic advertisement;
cause to be stored, on one or more storage mediums, ad impression data identifying:
i) the selected electronic advertisement as a candidate for later access, and
ii) one or more context attributes providing contextual information identifying a user interface environment in which the electronic advertisement was selected; and
provide the ad impression data including the identified one or more context attributes to a display device operable to display a presentation of the ad impression data in a user interface.

20. A non-transitory computer-readable storage medium storing instructions executable by a computing device to perform a method for preserving electronic advertisements identified during a computing session, the method comprising:
receiving user input data from or on behalf of a user, the user input data indicating a selection of an electronic advertisement;
causing to be stored, on one or more storage mediums, ad impression data identifying:
i) the selected electronic advertisement as a candidate for later access, and
ii) one or more context attributes providing contextual information identifying a user interface environment in which the electronic advertisement was selected; and
providing the ad impression data including the identified one or more context attributes to a display device operable to display a presentation of the ad impression data in a user interface.
